(19) United States
(12) Patent Application Publication
(10) Pub. No.: US 2016/0316113 A1
(43) Pub. Date: Oct. 27, 2016

(54) INTEGRATED PROCESSING AND PROJECTION DEVICE WITH OBJECT DETECTION

(71) Applicant: MICROSOFT TECHNOLOGY LICENSING, LLC, Redmond, WA (US)

(72) Inventors: Federico Zannier, Seattle, WA (US); Jean-Louis Villecroze, Redmond, WA (US); Karon Weber, Kirkland, WA (US)

(73) Assignee: MICROSOFT TECHNOLOGY LICENSING, LLC, Redmond, WA (US)

(21) Appl. No.: 14/697,432

(22) Filed: Apr. 27, 2015

(51) Int. Cl. H04N 5/225; H04N 9/07; H04N 5/33; H04L 29/08; H04N 5/232

(52) U.S. Cl. CPC H04N 5/2252; H04L 67/306; H04N 5/23293; H04N 5/33; H04N 9/07; H04N 5/23216

(57) ABSTRACT

An integrated processing and projection device adapted to be supported on a supporting surface. The device includes a processor and a projector designed to provide a display on the supporting surface of the device and adjacent to the device. Various sensors enable object and gesture detection in the display area. The technology integrates the various available sensors in the integrated processing and projection device to detect active and passive objects, as well as user gestures, in the display area using various techniques to integrate all available sensors and provide an accurate identification of such objects and gestures. The object and gesture detection may be utilized to provide feedback in the display area regarding the real object in the display area.

### BACKGROUND

The capabilities of computing devices have continuously expanded to include ever more capabilities and convenience. From personal computers integrated with monitors to wearable computers, computing devices have progressed toward integrated devices. Each of such integrated computing devices presents a unique set of problems which must be overcome to provide a truly integrated and natural computing experience.

Various types of sensors have been utilized in conjunction with integrated computing systems including RGB cameras in, for example, laptop computers. The sensors provide information to processing devices which may be utilized to perform limited identification of users and objects.

### SUMMARY

The technology, roughly described, is an integrated processing and projection device adapted to be supported on a supporting surface. The device includes a processor and a projector designed to provide a display on the supporting surface of the device and adjacent to the device. Various sensors enable object and gesture detection in the display area. The technology integrates the various available sensors in the integrated processing and projection device to detect active and passive objects, as well as user gestures, in the display area using various techniques to integrate all available sensors and provide an accurate identification of such objects and gestures. The object and gesture detection may be utilized to provide feedback in the display area regarding the real object in the display area.

An integrated processing system includes a display projector in a housing adapted to rest on a supporting surface. The display projector adapted to display an interface in a display area on the supporting surface. Sensors include at least a RGB camera in the housing and an infrared emitter and infrared detector. The RGB camera and the infrared detector each have a field of view, each field of view encompassing a detection area including at least the display area. A processor and memory are in the housing, with the memory including code operable to instruct the processor to monitor images from the RGB camera and the infrared detector and operable to detect one or more real objects in the detection area. The code is operable to identify the one or more real objects in the detection area.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a perspective view of an integrated processing and projection device on a supporting surface.

FIG. 2 depicts a side view of the integrated processing and projection device.

FIG. 3 is a block diagram depicting the internal components of the integrated processing and projection device.

FIGS. 4A, 4B, and 4C illustrate the expansion of the projection system in the integrated processing and projection device.

FIG. 5 is a partial side view of a second embodiment of an integrated processing and projection device.

FIG. 6 is a perspective view of a user manipulating a real object in a display area on a supporting surface.

FIG. 7 is a perspective view illustrating illumination and detection of data for a real object in a display area.

FIG. 8 is a second perspective view illustrating illumination and detection of data for a real object in a display area.

FIG. 9 is a flow diagram illustrating a first computer implemented process performed by an integrated processing and projection device to identify a real object.

FIG. 10 is a flow diagram illustrating a second computer implemented process performed by an integrated processing and projection device to identify a real object.

FIG. 11 is a flow diagram illustrating a computer implemented process performed by an integrated processing and projection device to match imaged data to real objects.

FIG. 12 is a flow diagram illustrating a computer implemented process performed by an integrated processing and projection device for calibration and weighting of devices.

FIG. 13 is a flow diagram illustrating a computer implemented process performed by an integrated processing and projection device for identifying a real object using isolated image capture data.

FIG. 14 is a flow diagram illustrating a computer implemented process performed by an integrated processing and projection device for gathering additional information to be utilized for real object identification.

FIG. 15 is an exemplary interface providing feedback and receiving input identifying the real object.

### DETAILED DESCRIPTION

Technology is presented wherein an integrated processing and projection device suitable for being supported on a supporting surface includes a processor and a projector designed to provide a display on the supporting surface of the device. Various sensors enable object and gesture detection in the display area. The technology integrates the various available sensors in the integrated processing and projection device to detect active and passive objects, as well as user gestures, in the display area using various techniques to integrate all available sensors and provide an accurate identification of such objects and gestures. The object and gesture detection may be utilized to provide feedback in the display area regarding the real object in the display area.

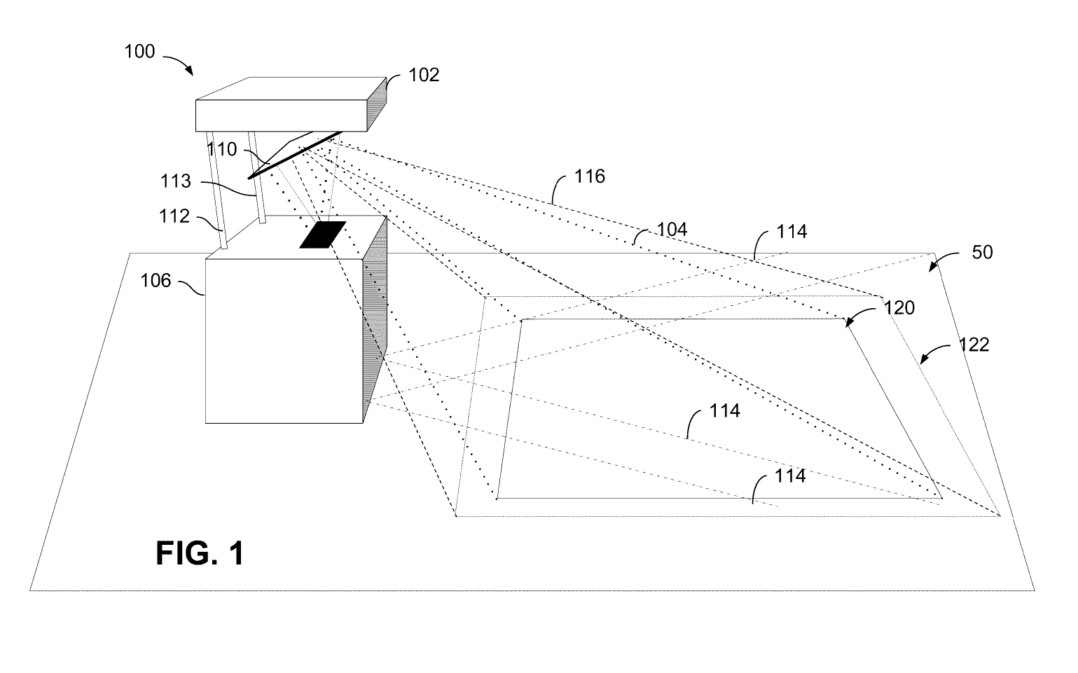

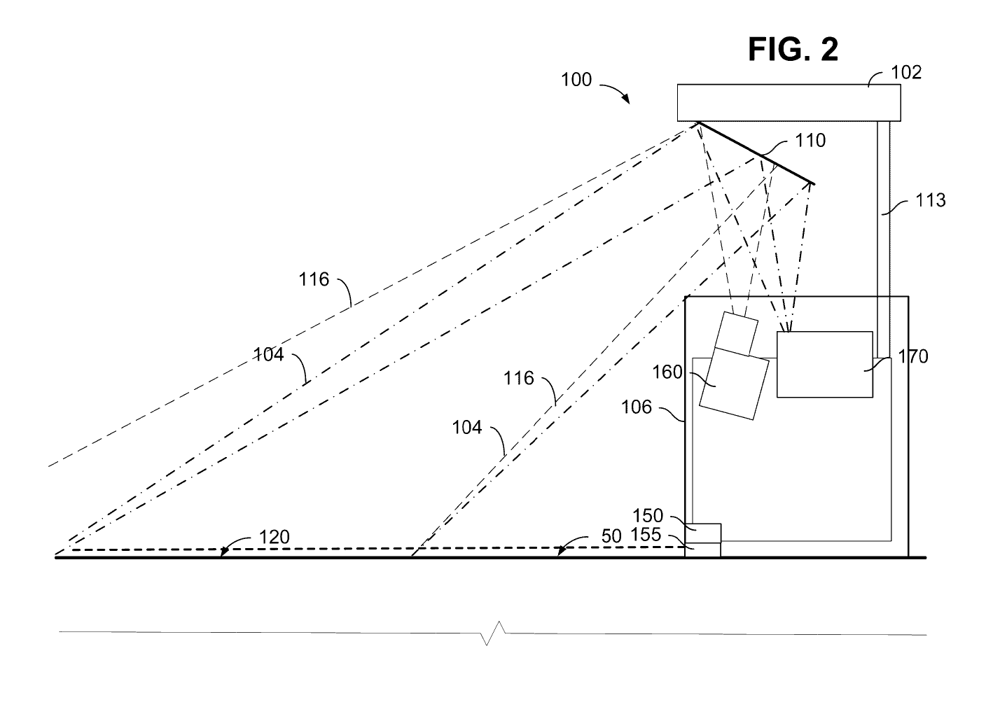

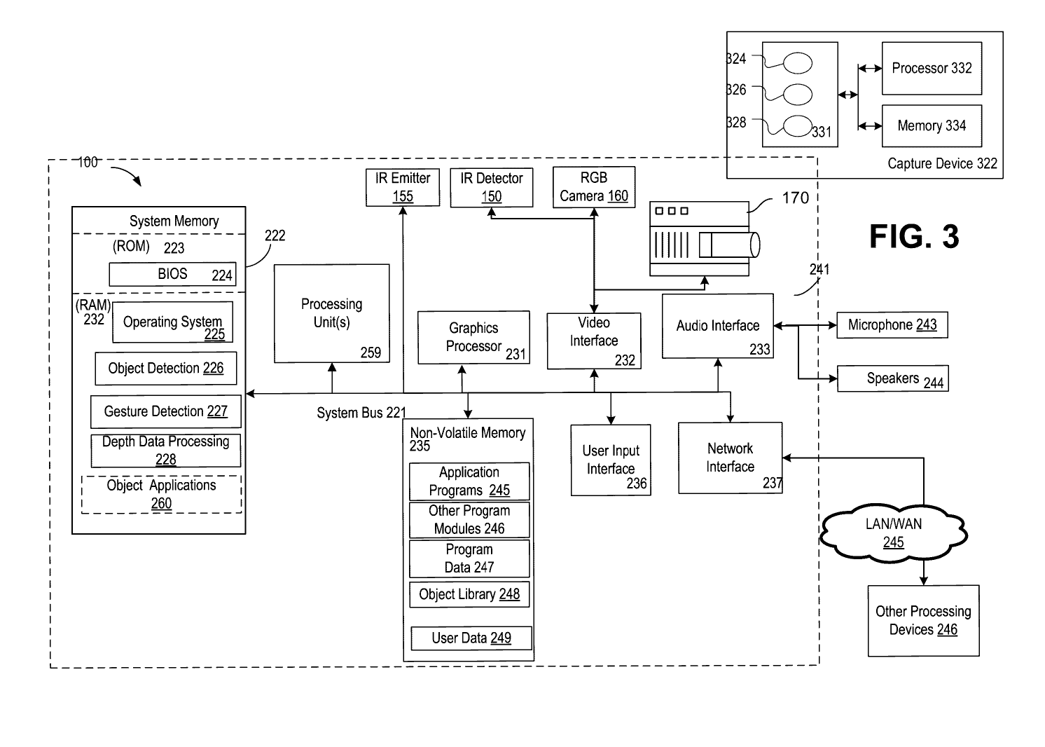

FIG. 1 illustrates a perspective view of an interactive processing and projection device 100. Interactive processing and projection device 100 will be described with respect to the various figures herein. FIG. 2 is a side view of the device 100 and FIG. 3 is a block diagram illustrating various components of device 100.

As illustrated in FIGS. 1-3, a first embodiment of an integrated processing and projection device 100 is designed to be supported on a supporting surface 50 and to project into a display area 120 various interfaces and interactive displays. Interfaces may be projected and used in the display area 120, with objects and gestures of users which occur in the display area being detected by various sensors and a processor in housing 106. Device 100 includes, in one embodiment, a projector 170, and sensors including an RGB camera 160, an infrared emitter 155 and an infrared detector or camera 150, all provided in housing 106. The sensors detect interactions in a detection area 122 which encompasses the display area 120. The housing 106 may be supported by any supporting surface 50 and may project a display area 120 onto the supporting surface or other surfaces as described herein. Various components provided in housing 106 are illustrated in FIG. 3.

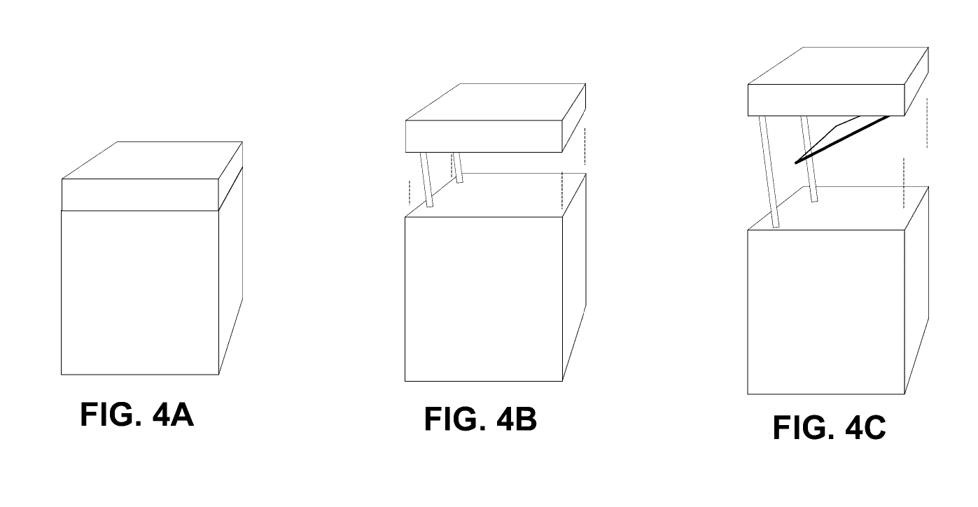

Housing 106 includes a lid portion 102 having mounted therein a rotatable mirror 110. Lid 102 is supported by arms 112, 113 which can raise and lower lid 102 as illustrated in FIGS. 4A through 4C. Arms 112, 113 are connected to lid 102 at one end and motors (not shown) provided in the housing 106 which operate to raise and lower the lid. Mirror 110 in lid 102 provides both an output for the projector 170 and reflects the display area 120 into a field of view for RGB camera 160. FIG. 4A illustrates the closed position of the device 100, FIG. 4B illustrates a partially raised lid 102 and FIG. 4C illustrates a fully raised lid 102 with mirror 110 rotated into a fully extended position. Mirror 110 can be mounted on a spring-loaded hinge or mounted to a motor and hinge (not shown) to allow extension and retraction of the mirror 110 between the open and closed positions illustrated in FIGS. 4C and 4A respectively.

As illustrated in FIGS. 1 and 2, infrared emitters which may comprise infrared light emitting diodes (LEDs) illuminate a detection area 122 which in one embodiment is larger than the display area 120. Emitters 155 are mounted near the bottom of the housing 106 so as to illuminate an area of the supporting surface in the display area 120 adjacent to the supporting surface 50. IR illumination represented at 114 illuminates any object close to the surface 50 in the projection area 120 and is useful in detecting surface interactions by objects and user hands. Projector emissions 104 from the projector 170 illuminate the projection area 120 with visible light. The field of view 116 of camera 160 may be larger than the projection area 120 and encompass the detection area 122.

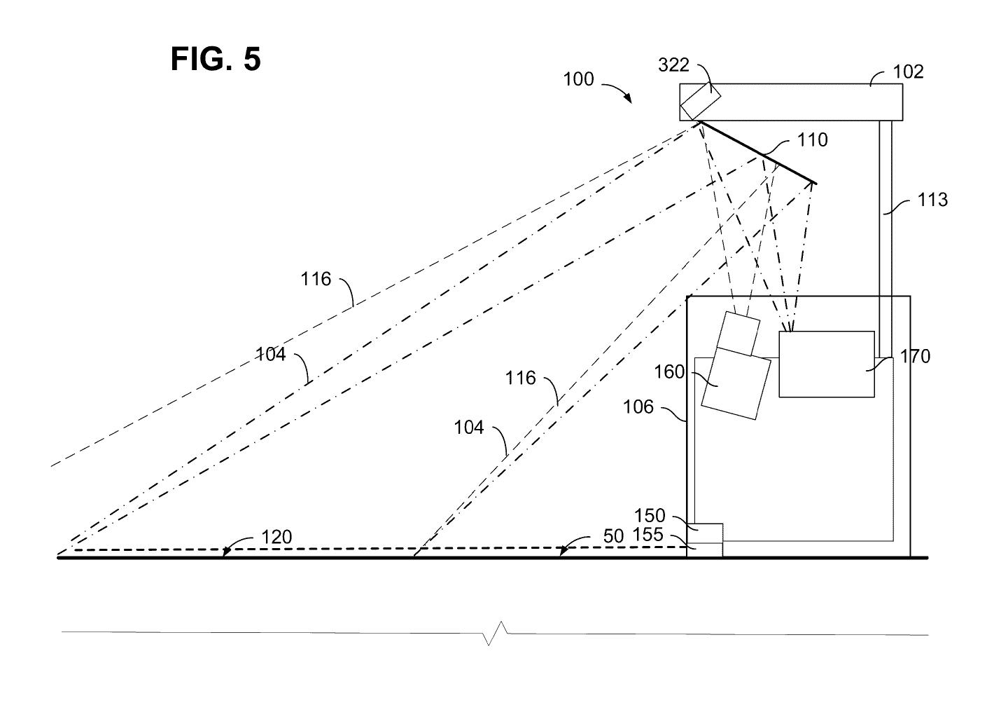

A second embodiment of device 100 is illustrated in FIG. 5. The embodiment of FIG. 5 includes the components of the embodiment of FIGS. 1-2 and further includes a capture device 322. The capture device may be positioned in a manner that it is focused at the detection area 122, or may alternatively have other positions and be directed to detect and track users who are proximate to device 100.

FIG. 3 illustrates the components which may be included in the both embodiments of the apparatus 100. Differences between the respective embodiments will be noted where applicable. (For example, in FIG. 3, a capture device 322 is illustrated but it should be understood that in one embodiment such as that illustrated with respect to FIGS. 1 and 2, no capture device need be used.) The components of device 100 are one example of a suitable computing environment and is not intended to suggest any limitation as to the scope of use or functionality of the present system. Neither should the device 100 be interpreted as having any dependency or requirement relating to any one or combination of components illustrated in the exemplary device100.

With reference to FIG. 3, an exemplary device 100 for use in performing the above-described methods includes a one or more processors 259 adapted to execute instructions in the form of code to implement the various methods described herein. Components of computing system 300 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 222 includes computer storage media in the form of volatile and/or nonvolatile memory such as read only memory (ROM) 223 and random access memory (RAM) 232. A basic input/output system (BIOS) 224, containing the basic routines that help to transfer information between elements within device 100, such as during start-up, is typically stored in ROM 223. RAM 232 typically contains data and/or program modules that are immediately accessible to and/or presently being operated on by processing unit 259. By way of example, and not limitation, FIG. 3 illustrates operating system 225, an object detection component 225, a gesture recognition component 227, a depth data processing component 228 (for the embodiment of FIG. 5) and an interaction service component 229a.

Object detection component 226 includes instructions for enabling the processing units 259 to detect both passive and active objects in the object detection area 122. Gesture detection component 227 allows detection of user hand and object gestures within the detection area 122. Depth data processing component 228 allows for the depth image data provided by capture device 322 to be utilized in conjunction with the RGB image data and the IR detector data to determine any of the objects or gestures described herein. Interaction service component 229a provides a communication path to allow users with other processing devices to communicate with the device 100.

Device 100 may also include other removable/non-removable, volatile/nonvolatile computer storage media. By way of example only, FIG. 3 illustrates non-volatile memory 235 which may comprise a hard disk drive, solid state drive, or any other removable or non-removable, nonvolatile magnetic media including magnetic tape cassettes, flash memory cards, DVDs, digital video tape, solid state RAM, solid state ROM, and the like. The non-volatile media illustrated in FIG. 3 provide storage of computer readable instructions, data structures, program modules and other data for device 100. In FIG. 3, for example, non-volatile memory 235 is illustrated as storing operating system application programs 245, other program modules 246, and program data 246 another object library 248 and user data 249. Non-volatile memory 235 may store other components such as the operating system and application programs (not shown) for use by processing units 259. A user may enter commands and information into the computer 241 through input interfaces projected into the detection area 122, or through conventional input devices such as a keyboard and pointing device. These and other input devices are often connected to the processing unit 259 through a user input interface 236 that is coupled to the system bus, but may be connected by other interface and bus structures, such as a parallel port, game port or a universal serial bus (USB).

The computer 241 may operate in a networked environment using logical connections to one or more remote computers, such as a remote computer 246. The remote computer 246 may be a personal computer, a server, a router, a network PC, a peer device or other common network node. The logical connections depicted include a local area network (LAN) and a wide area network (WAN) 245, but may also include other networks. Such networking environments are commonplace in offices, enterprise-wide computer networks, intranets and the Internet. When used in a LAN networking environment, the computer 241 is connected to the LAN/WAN 245 through a network interface or adapter 237. In a networked environment, program modules depicted relative to the computing system 100, or portions thereof, may be stored in the remote processing devices 246.

The RGB camera 160 and IR detector 150 may be coupled to a video interface 232 which processes input prior to input to the processing units 259. A graphics processor 231 may be utilized to offload rendering tasks from the processing units 259. IR Emitter 150 operates under the control of processing units 259. Projector 170 is coupled to video interface 232 to output content to the display area 120. Video interface 232 operates in conjunction with user input interface 236 to interpret input gestures and controls from a user which may be provided in the display area 122.

A user may enter commands and information into the device 100 through conventional input devices, but optimally a user interface is provided by the projector 170 into the display area 120 when input is utilized by any of the applications operation on or in conjunction with device 100.

A capture device 322 may optionally be provided in one embodiment as shown in FIG. 5. Capture device 322 includes an image camera component having an IR light component 324, a three-dimensional (3-D) camera 326, and a second RGB camera 328, all of which may be used to capture the depth image of a capture area 122. The depth image may include a two-dimensional (2-D) pixel area of the captured scene where each pixel in the 2-D pixel area may represent a depth value such as a distance in, for example, centimeters, millimeters, or the like of an object in the captured scene from the image camera component 331.

In time-of-flight analysis, the IR light component 324 of the capture device 322 may emit an infrared light onto the capture area and may then use sensors to detect the backscattered light from the surface of one or more objects in the capture area using, for example, the 3-D camera 326 and/or the RGB camera 328. In some embodiments, pulsed infrared light may be used such that the time between an outgoing light pulse and a corresponding incoming light pulse may be measured and used to determine a physical distance from the capture device 322 to a particular location on the one or more objects in the capture area. Additionally, the phase of the outgoing light wave may be compared to the phase of the incoming light wave to determine a phase shift. The phase shift may then be used to determine a physical distance from the capture device to a particular location associated with the one or more objects.

In another example, the capture device 20 may use structured light to capture depth information. In such an analysis, patterned light (i.e., light displayed as a known pattern such as grid pattern or a stripe pattern) may be projected onto the capture area via, for example, the IR light component 324. Upon striking the surface of one or more objects (or targets) in the capture area, the pattern may become deformed in response. Such a deformation of the pattern may be captured by, for example, the 3-D camera 326 and/or the RGB camera 328 and analyzed to determine a physical distance from the capture device to a particular location on the one or more objects. Capture device 322 may include optics for producing collimated light. In some embodiments, a laser projector may be used to create a structured light pattern. The light projector may include a laser, laser diode, and/or LED.

The capture device 322 may include a processor 332 that may be in communication with the image camera component 331. The processor 332 may include a standardized processor, a specialized processor, a microprocessor, or the like. The processor 332 may execute instructions that may include instructions for receiving and analyzing images. It is to be understood that at least some image analysis and/or target analysis and tracking operations may be executed by processors contained within one or more capture devices such as capture device 322.

The capture device 322 may include a memory 334 that may store the instructions that may be executed by the processor 332, images or frames of images captured by the 3-D camera or RGB camera, filters or profiles, or any other suitable information, images, or the like. As depicted, the memory 334 may be a separate component in communication with the image capture component 331 and the processor 332. In another embodiment, the memory 334 may be integrated into the processor 334 and/or the image capture component 331.

The capture device 322 may be in communication with the device 100 via a communication link. The communication link 46 may be a wired connection including, for example, a USB connection, a FireWire connection, an Ethernet cable connection, or the like and/or a wireless connection such as a wireless 802.11b, g, a, or n connection.

The cameras 326, 328 and capture device 331 may define additional input devices for the device 100 that connect via user input interface 236. In addition, device 100 may incorporate a microphone 243 and speakers 244 coupled to an audio interface 233.

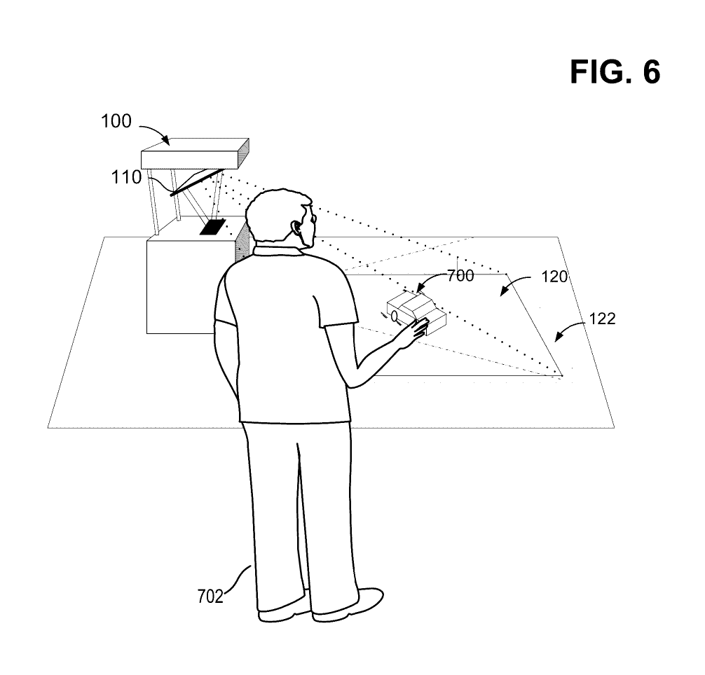

FIG. 6 illustrates a perspective view of a user 702 manipulating a real object 700 on the supporting surface 50 and within the display area 120 and detection area 122. It should be noted that the detection area 122 encompasses the display area and may be larger than the display area 120. In operation, any number of active (controllable to perform certain functions) objects and passive real objects 700 may be placed in the display area 120. Objects 700 placed in the display area 120 and in the detection area 122 are identified by the integrated processing and display apparatus 100 and provide feedback for the real object 700 may thereafter be provided in accordance with any number of different object applications 260 running on device 100.

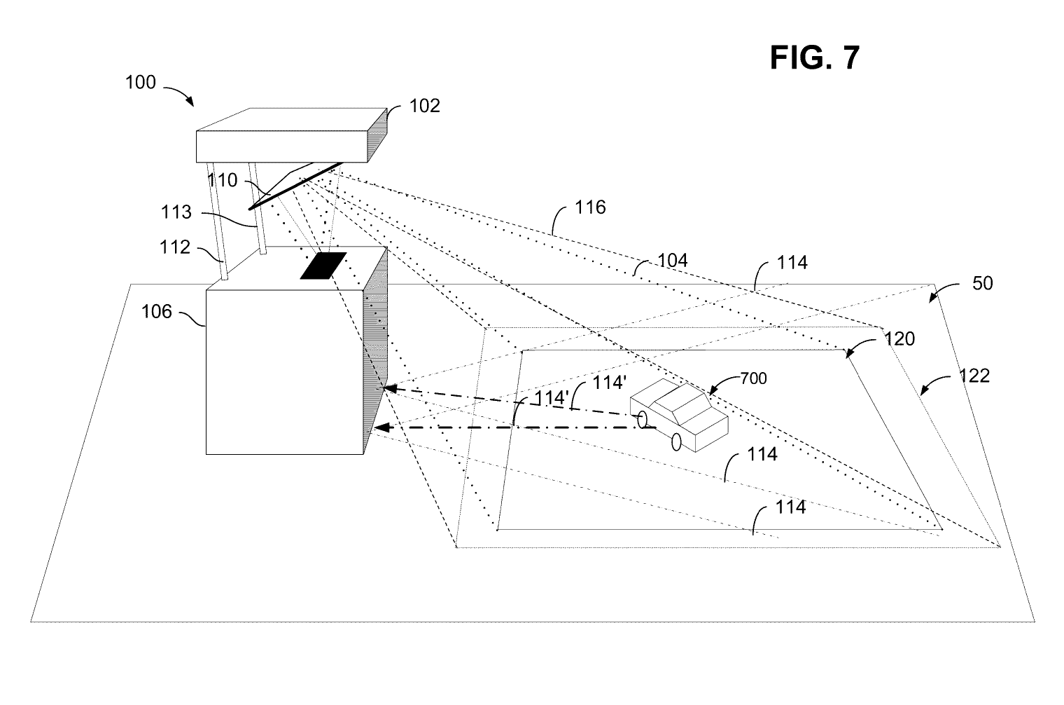

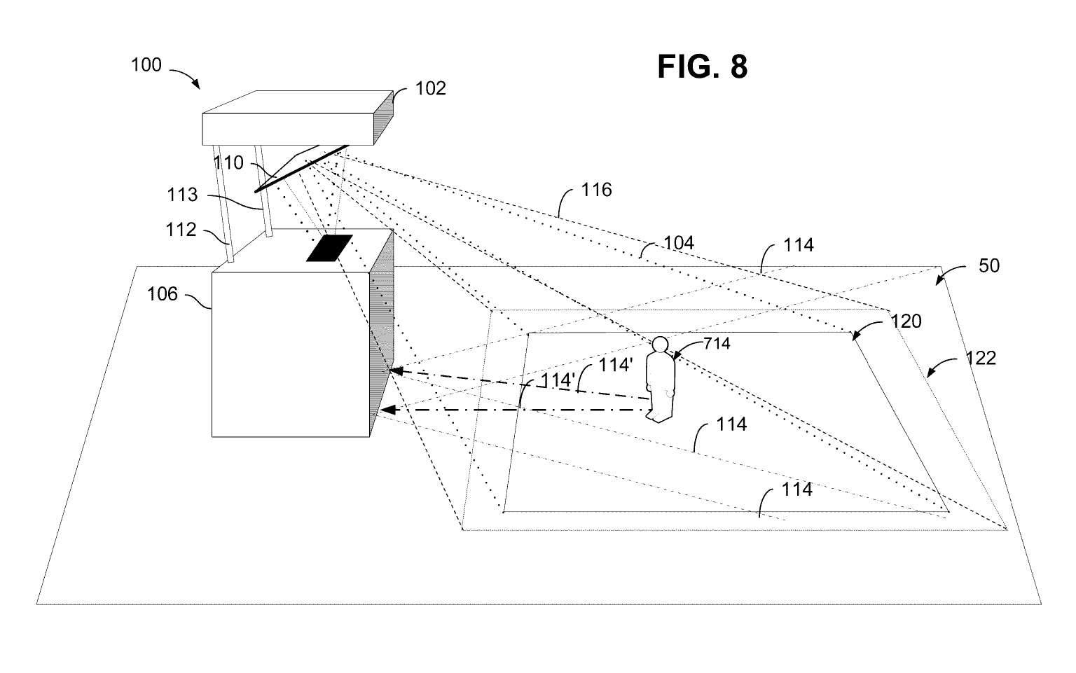

FIG. 7 illustrates the sensors including RGB camera 160 and IR detector 150 receiving input from the real objects 700 in the detection area 122 and display area 120. As illustrated therein, illumination 104 from the projector 170 illuminates the display area 120, allowing the RGB camera 162 (having a field of view indicated by lines 116) to receive an image of the detection area 122 and generate image data for use in identifying the object 700. Likewise, the IR emitter beams 114 reflect off of the object 700 and return at 114′ to the IR detectors 150. In the example shown in FIGS. 6 and 7, real object 700 is a car. However, as illustrated in FIG. 8, the real object may comprise a figurine 704. To distinguish between, for example, the car 700 and the object 704, image search techniques may be utilized in accordance with the various image search and comparison algorithms known in the art. In both the embodiments of FIG. 7 and FIG. 8, it should be understood that while the apparatus illustrated without a capture device 322, an apparatus as illustrated in FIG. 5, including a capture device may be utilized in order to identify either the objects 700 or 704.

In addition, objects 700, 704 may be active or passive object. Passive objects are those which have no controllable features. Controllable features may be those which cause the object to perform some function. For example, a car object may have a motor which allows the wheels of the car to turn or a sound generator to emit simulated engine noise. A toy helicopter may have a motor to rotate various parts of the helicopter. Any number of active objects may be utilized in accordance with the teachings herein. In some embodiments, active objects have communication channels allowing the active objects to communicate with other devices to enable features of the object. For example, where object 700 is an active object, the object 700 may include a Bluetooth communication channel allowing device 100 to connect to object 700 and provide instructions to object 700. The nature of the communication channel in the object may be any number of different communication transport mechanisms, including Bluetooth, RF, WiFi and other wireless transport schemes.

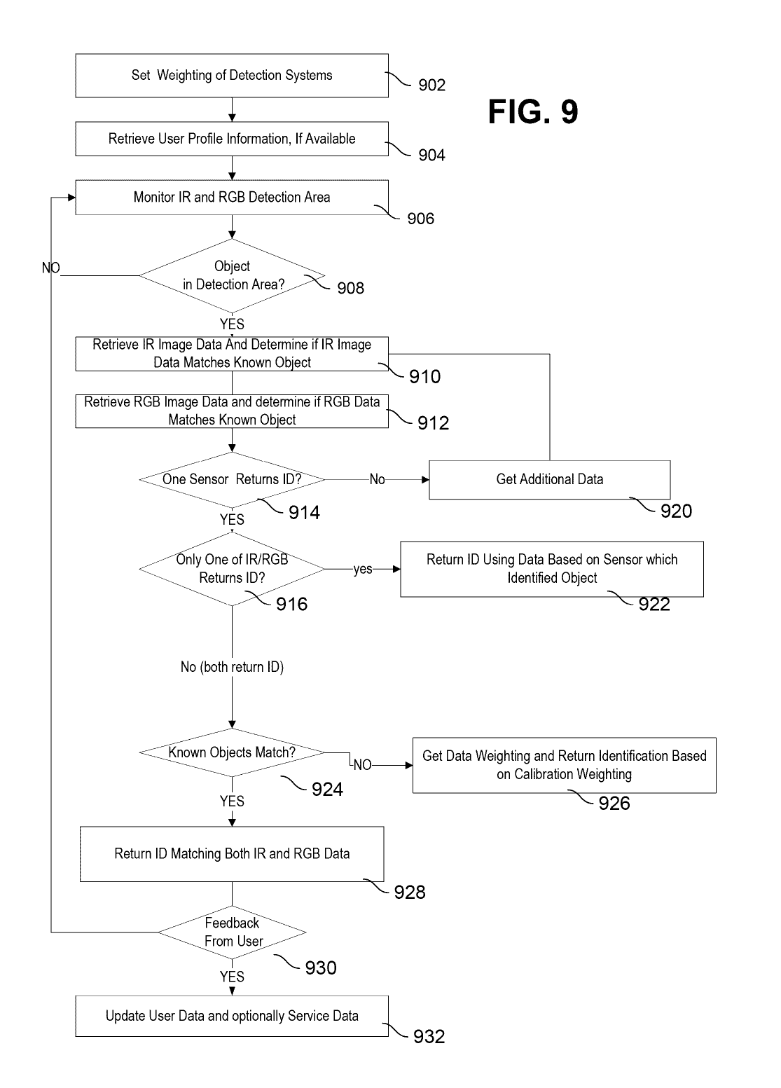

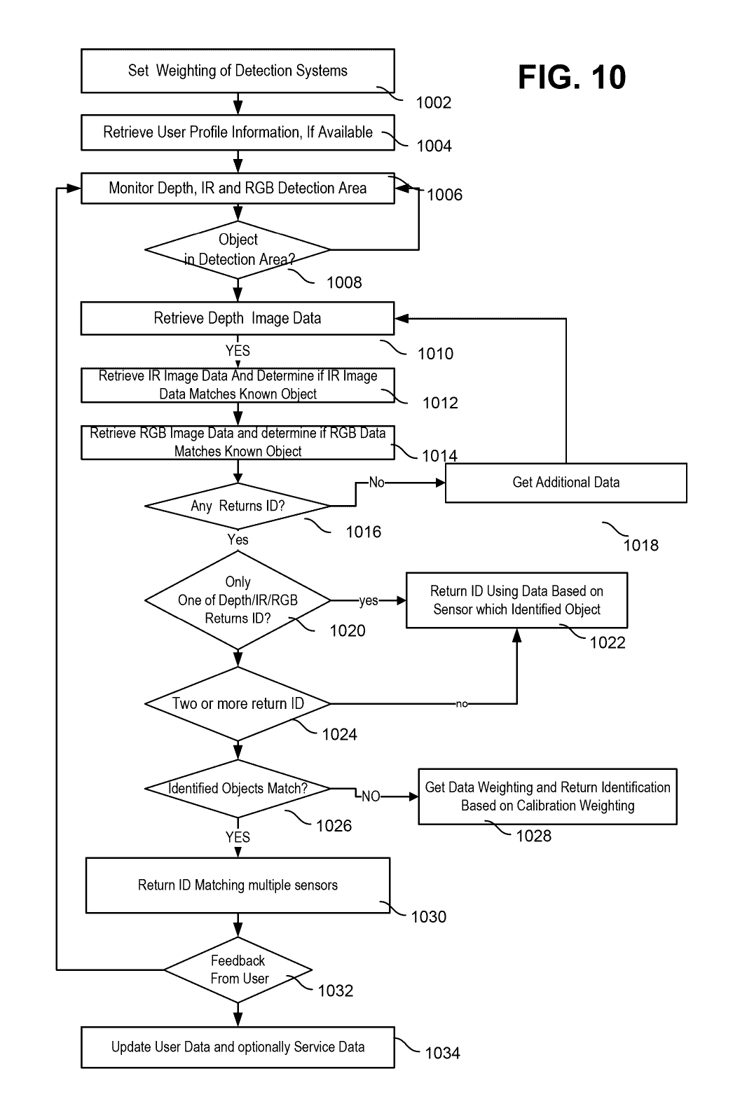

FIG. 9 is a flowchart illustrating one embodiment of a processor implemented method which may be performed by device 100 for detecting and identifying a real object in the detection area 122. In the embodiment in FIG. 9, two sensors—the IR detector 150 and the RGB camera 160—are illustrated. FIG. 10 illustrates an alternative embodiment utilizing three different sensors—the RGB camera 160, the IR detector 150, and the capture device 322.

At 902, a weighting of detection systems is determined. In this case, a “detection system” includes a sensor (RGB camera and IR detector/Illumination) and associated image to object matching. The weighting of detection systems may be set to provide additional credence to one of the different detection systems—the RGB camera 160 or the IR detector 150—based on any number of different factors. For example, if there is an excess of ambient lighting in the detection area 122, additional credence may be given to data from the IR detector. At 904, user profile information, if available, is retrieved. User profile information can be utilized in determining the types of real objects which a particular user has interacted with in the past. If the user utilizes a particular real object, such as a toy car, and a car is placed in the detection area 122, is likely that the object in the detection area will be the same car, and the user is more likely request the same types of feedback. At 906, the detection area 122 is monitored for sensor input. Monitoring for sensor input includes monitoring the image data from each sensor to determine a change in the data for which object matching should begin. At 908, a determination is made as to whether not an object has entered the detection area. If not, the method loops to step 906 to continue monitoring the detection area. If so, then the IR image data is examined to determine if the IR image data matches a known object at 910. Additionally, the RGB image data is acquired and a determination is made as to whether not the RGB image data matches a known object at 912.

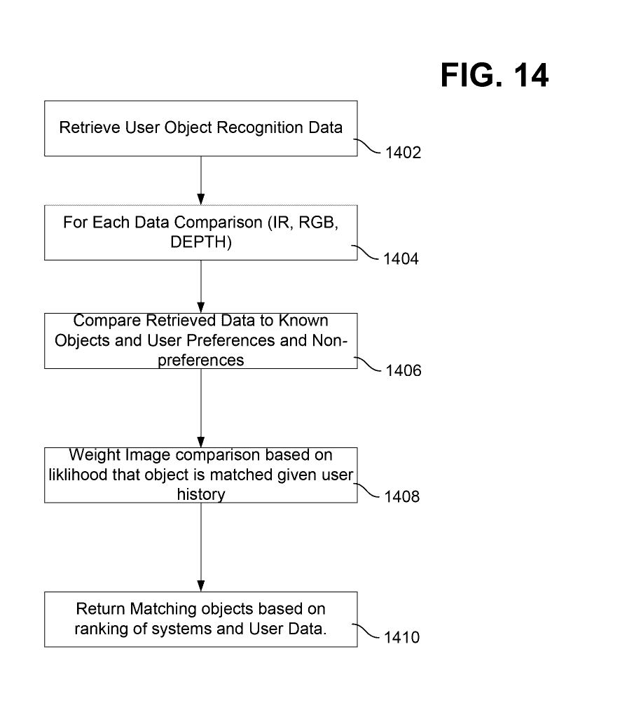

At 914, if neither the IR image data nor the RGB image data matches a known object, then additional data is gathered at 920. Additional data can be used to determine the nature of the object and can include prompting a user for input on the object and/or performing a search of publically available data which may aid in identifying the object in the detection area 122. A method of gathering additional data is illustrated in FIG. 14. If one of the sensor data types provides an identification of an object, then if only one of the sensors has returned object data at 916, an identification based on data returned by a single sensor is provided at 922. If both of the sensors has returned a match at 916, then a determination is made at step 924 as to whether the object identified by each sensor match. If the known objects match at step 924, then the identification matching both the IR and RGB image data is returned at 928. If the objects do not match, then the weighting set in step 902 is returned at step 926 and identification of the object is determined based on the calibration weighting at 926. Weighting may be a simple priority—one sensor takes priority over the other—or may be more evaluative, taking multiple possible identifications of objects and assigning a relative value of each sensor to possible matches to determine if overlap between the sensors has occurred. For example, if the IR sensor data indicated possible matches of (in order preference) of a tank object, a car object, and a box object, and RGB image data indicates matches (in order preference) of a box object, a book object and a car object and the IR data is afforded a greater weight, the car object (identified by both) may be returned since although the IR object returned a tank object as a first choice, both sensors returned the car and although the IR data has greater weight, the RGB data weight still contributes to the determination.

Alternatively the sensors may be weighted by time. In one alternative, the sensor data which returns the quickest identification is given greater weight than other sensors which take longer.

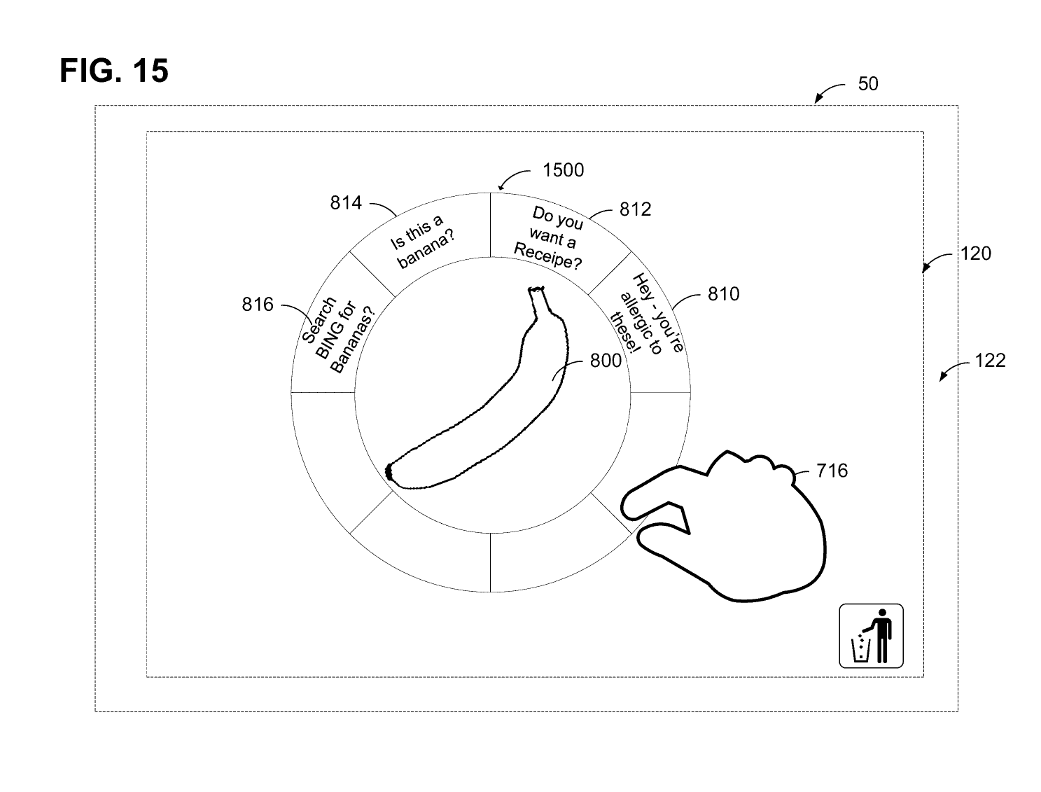

Optionally, at 930, feedback from the user may be requested to determine whether or not the object identified is accurate. Feedback may be provided by displaying an interface next to the object as shown in FIG. 15, discussed below. If feedback is not requested, the method returns to step 906 to monitor the IR and RGB detection area. If feedback is requested at 930, then the user data is updated and the service data is updated at step 932.

FIG. 10 illustrates an embodiment, wherein three sensors are utilized—the IR detector 150, the RGB camera 160, and the capture device 322 using a device 100 configured as in FIG. 5 herein. At step 1002, the weighting of the detection systems is established. Step 1002 is similar to step 902, except that the three sensor relative weighting is utilized. At step 1004, user profile information, if available, is retrieved. At step 1006, depth data, IR data, and RGB data, are monitored in the detection area. If an object is detected in the detection area. At 1008, a determination is made as to whether or not one of the data sources indicates an object in the detection area 122. Initially, depth image data is retrieved at step 1010, and a determination is made as to whether or not an object matches the data from the depth image data. Similarly, at step 1012, IR image data is retrieved to determine if the IR image matches a known object. Finally, at step 1014, RGB image data is retrieved to determine if RGB didn't matches a known object. It should be noted that tthe particular order of steps 1010, 1012 and 1014 need not be that shown, and that the steps may be re-ordered in any manner or performed in parallel. In a manner similar to FIG. 9, if none of the data returns a known identification of an object in the detection and area, then at step 1018, additional data is retrieved an attempt to determine the object. If only one of the sensors returns and identification at 1020, then the identification of the object using the data returned from the sensor which identifies the object is returned at 1022. At 1024, if two or more of the sensors return an identification of the object, then a determination is made at 1026, as to whether or not the identified objects match. The identified objects do not match, the weighting of the respective turned identifications based on the different sensors is returned at 1028 and the identification of the object is based on the weighting of the different sensors. If the identified objects from each of the data from the various sensors match at 1026, then an identification of the objects returned based on the known multiple image identification of the objects at 1030. In a manner similar to FIG. 9, feedback from the user may be requested at step 1032 and if so, an update to the user data and the service data may be applied at 1034.

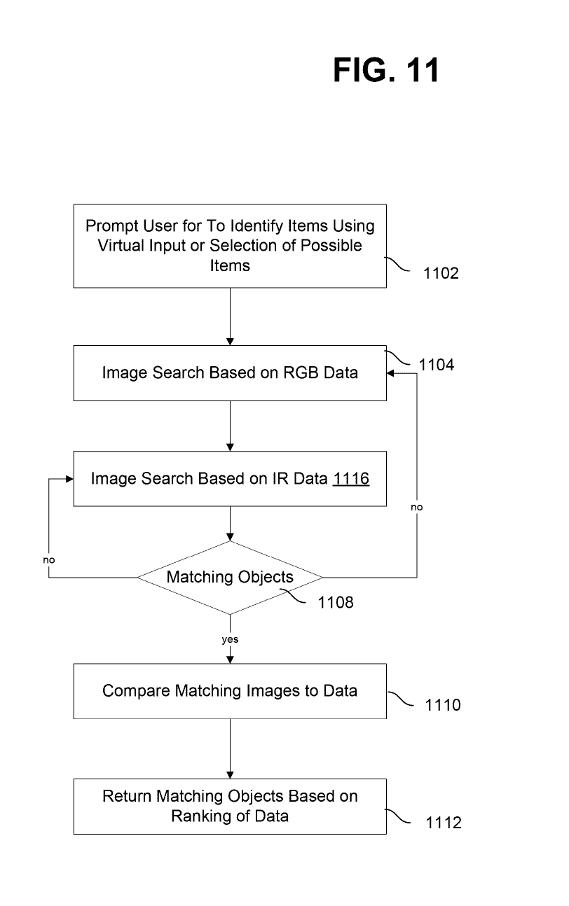

FIG. 11 illustrates one method for performing steps 920 and 1018 of FIGS. 9 and 10, respectively. FIG. 11 illustrates method for obtaining additional data from, for example, user or any number of different publicly and privately available data sources. An example of one of the publicly available data sources is a search of data available from publicly accessible sources on the Internet using a commercial search engine, such as Bing®. At step 1102, the user may be prompted to identify items using a virtual input or selection of potential items available from the input. Additionally, an image search based on RGB data may be conducted at 1104. The image search may use any of a number of pattern matching techniques to match sensor data to known images of objects. In addition, an image search based on infrared data may be conducted at 1126. If valid search objects are returned at 1108, then a comparison is made to the image is returned matching the data returned from the respective sensors. Data searching can continue from 1108 for a timed period or until valid data is returned. Finally, an identification is made at step 1122 based on the returns of the data searches conducted at 1104 and 1106.

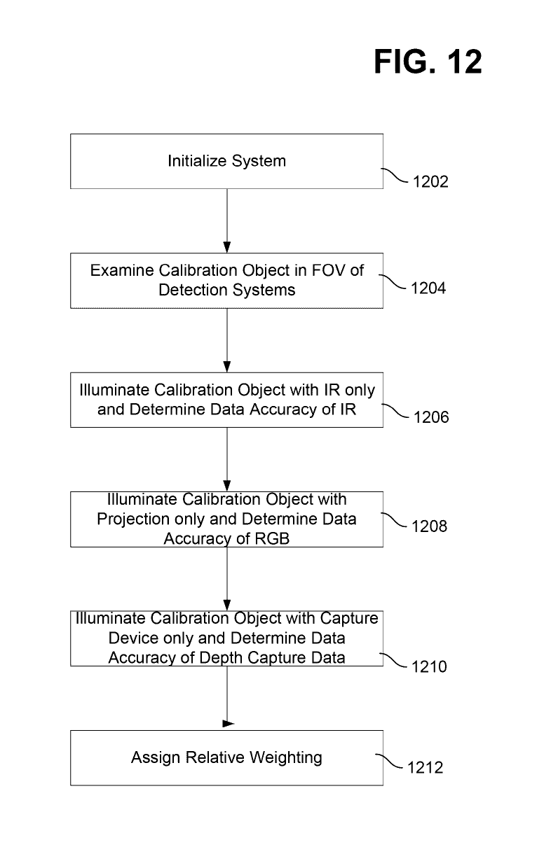

FIG. 12 illustrates one step for weighting the respective sensors in a device 100. FIG. 12 illustrates a calibration procedure which may be utilized in determining the respective weights applied to the different sensors. At step 1202, a system initialization occurs. At 1204 a calibration object is placed in the field of view of the detection systems and examined as described below. The calibration object to be any object which is, or can be known in advance to the device 100. At step 1206, the calibration object is illuminated with infrared only (no projection illumination from the projector 170 or IR from the capture device) using the IR emitters 155 and the accuracy of the IR detectors 150 is determined. Subsequently, the IR emitters are turned off and the object is illuminated with the projector 170 and the RGB data captured at 1208. This allows determination of the accuracy of the RGB data at 1208. Finally, at 1210, if a capture device 322 is available, the calibration object is illuminated with IR from the capture device and actually accuracy of the depth captured it is determined at 1210. At step 1212, the relative sensors is weighted based on the data acquired its steps 1204, 1206, and 1208. Because the calibration object is known, an accuracy of the data from each sensor compared to a ground truth representation of each type of data for each sensor yields an accuracy which may be used to weight the sensor accordingly.

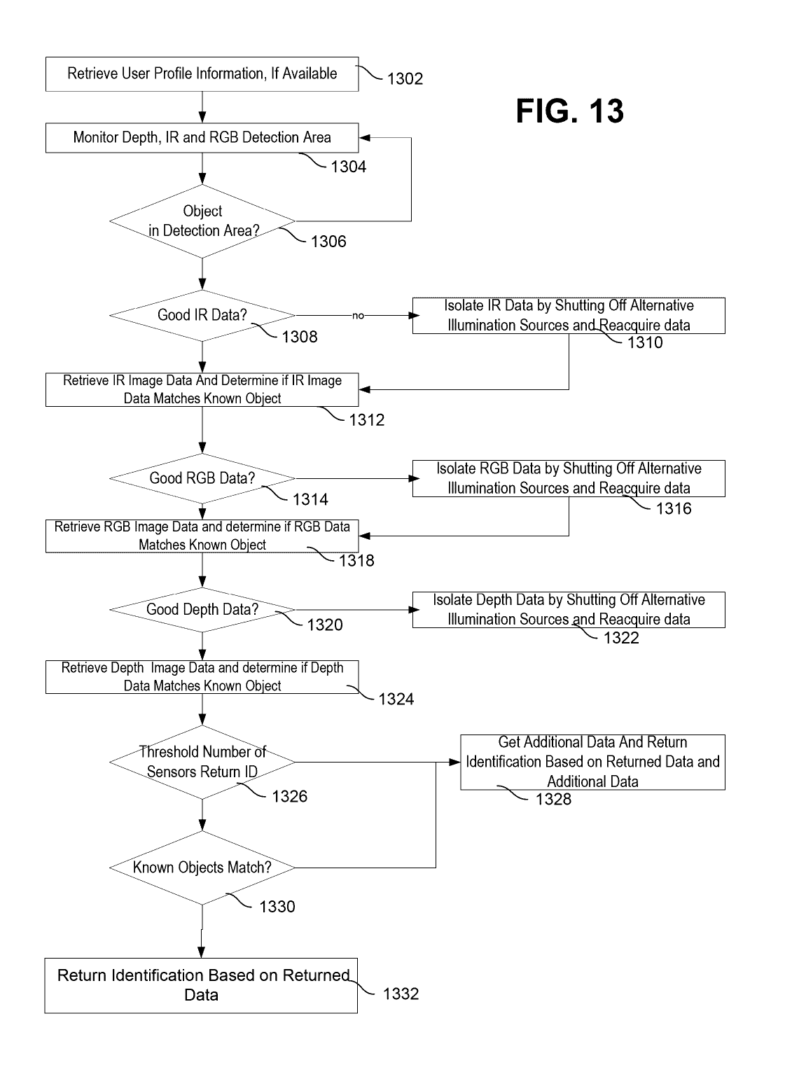

FIG. 13 is an alternative method for determining identification of an object in a detection area 122. In this alternative, one or more sensors are isolated to obtain identification data. In this alternative, weighting need not be used, but weighting may be used if desired. At step 1302, user profile information, if available, is retrieved. At step 1304, depth, IR, and RGB data is monitored and detection area 122 to determine, at 1306, whether an object is in the detection area at 1306. If not the method continues to monitor data until an object is perceived in the detection area 122. At 1308, an initial determination is made as to whether not the IR data is good. A determination of whether data in any of steps 1308, 1314 or 1320 is good is based on a statistical sampling of noise in the data returned by the sensor. If the IR data is not determined to be of sufficient resolution, at 1308, then at 1310 IR data may be isolated by shutting off alternative illumination sources such as the RGB projector and the IR elimination from the capture device 322, and IR data from illumination source 155 and detector 150 is then reacquired at 1310. If the IR data is determined to be above a particular threshold of noise at 1308, IR image data is retrieved and used to determine if the image data matches a known object at 1312. Next, a determination is made at 1314 as to whether or not the RGB image data is sufficient to identify an object. In a manner similar to the IR sensor, if the RGB data is not good at 1314, then the RGB data acquisition is isolated by shutting off alternative illumination sources and reacquiring the RGB data at 1316. Once the RGB data is reacquired, or if the RGB is good at 1314, then the RGB image data is retrieved and a determination made at 1318 as to whether an object in detection area 122 can be identified. Next, a similar process is utilized with the depth data if a capture device is available. If good depth data is not acquired at 1320, then the depth data is isolated 1322 by shutting off alternative illumination sources and reacquiring the depth data at 1322. Following the reacquisition, or if the depth if is good at 1320, the depth data is utilized to determine whether the depth data matches a known object 1324. If a threshold number of the above sensors return a good identification of the object at 1326, and the known objects match at 1330, then the identification is returned based on known matching data at 1332. The threshold may be one or two or all three sensors. If the threshold number of sensor do not return a good identification at 1326, then additional data is retrieved at 1328 (by for example looping to step 1308 and repeating the process) and identification of the object is returned based on the returned data and new additional data at 1328.

In another alternative, steps 1310, 1316 and 1322 isolating the image capture data for each of the various sensors may be used in conjunction with the methods of FIGS. 9 and 10. That is, step 1310 may be utilized in conjunction with steps 910 or 1012, step 1316 in conjunction with steps 912 or 1014, and step 1322 in conjunction with step 1010.

FIG. 14 illustrates a comparison process used for any of the identification steps where data is compared to object data for identifying objects in the detection area 122. Initially, at 1402, user object recognition data is retrieved. User object recognition data may define, for example, whether particular user has repeatedly placed a certain object in the detection area 122. For example, if a user constantly places a certain figurine or certain food type, or is allergic to certain food types, it may alter a determination for or against a particular object. If so, this altering based on user data can be applied to the matching of data from any of the sensors to determine whether a particular object matches in the detection area. For each data comparison set of data (IR, RGB, or depth) at 1404, a comparison of the retrieved data from each particular sensor is made to a known object and user preference in the user data retrieved at 1406. At 1408, a weighting of the image comparison is made based on the user data and the likelihood that the object match would be the object in the detection area. For example, if it is known that a user is allergic to bananas, the object is less likely to be a banana. However, if there is a high confidence that the object is a banana, then that information can be used with the user profile information to prompt or warn the user that the item is a banana and should be avoided. At 1310, the match is returned based on the known objects weighted in accordance with in the user history.

FIG. 15 illustrates an exemplary user interface allowing user to provide feedback on the real object 800 in a detection area 122. Illustrated in FIG. 14 is a display menu 1500 which is illustrated as a circular data structure surrounding a real object 800, which in this example is a banana. A number of touch sensitive display areas 810, 812, 814, 816, allow the user to select one of a different number of input prompts provided by the device 100. Each prompt may, for example, provide options to allow the user to specifically identify the real object 800, or provide preferences on what type of information the user may provide with respect to the object 800. For example, if the device determines that the object is banana, any number of different types of information may be provided for the item. For example, the user may wish to know more about bananas in general and initiate a BING search 814. The user may know which type of banana or nutritional information is available about the banana, or the user may request information on recipes (812) which may be utilized incorporating ingredients of bananas. In order to allow the device to specifically identify both the type of real objects 800 that is available in the type of information, a number of various different types of user interfaces 1500 may be provided.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

For purposes of this document, reference in the specification to “an embodiment,” “one embodiment,” “some embodiments,” or “another embodiment” may be used to describe different embodiments and do not necessarily refer to the same embodiment.

For purposes of this document, the term “set” of objects refers to a “set” of one or more of the objects.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

### EXEMPLARY EMBODIMENTS

Exemplary embodiments of the technology include an integrated processing system, comprising: a display projector in a housing adapted to rest on a supporting surface, the display projector adapted to display an interface in a display area on the supporting surface; a RGB camera in the housing; an infrared emitter and infrared detector, wherein the RGB camera and the infrared detector each have a field of view, each field of view encompassing a detection area including at least the display area; and a processor and memory including code operable to instruct the processor to monitor images from the RGB camera and the infrared detector and operable to detect one or more real objects in the detection area, the code operable to identify the one or more real objects in the detection area.

Embodiments of the technology further include any of the aforementioned embodiments wherein the code is operable to provide feedback for the one or more real objects using the display projector in the display area.

Embodiments of the technology further include any of the aforementioned embodiments in combination wherein the code is operable to retrieve user profile information for one or more users proximate to the system and to identify the real object based in part on information provided in the user profile.

Embodiments of the technology further include any of the aforementioned embodiments in combination wherein the code includes assigning a relative weight to each of data from the RGB camera and the infrared detector, and the code operable to identify the one or more real objects is based on the relative weight of each said data.

Embodiments of the technology further include any of the aforementioned embodiments in combination and further including code operable to control the RGB camera and the infrared emitter and infrared detector to isolate data capture for images from the RGB camera in a first time period and isolate data capture for images from the infrared detector in a second time period.

Embodiments of the technology further include any of the aforementioned embodiments in combination and further including code operable to display a selection interface in the display area, the selection interface responsive to user input to identify the object based on the user input.

Embodiments of the technology further include any of the aforementioned embodiments in combination and further including code operable to search publically available network content for identification information, the code operable to identify the one or more real objects identifying the real objects based in part on the publically available network content.

Embodiments of the technology further include any of the aforementioned embodiments in combination wherein the code operable to identify the one or more real objects identifying the real objects based in part on images from the RGB camera and images from the infrared detector both matching a recognized object.

Embodiments of the technology further include any of the aforementioned embodiments in combination and further including a depth camera, the code operable to identify the one or more real objects identifying the real objects based in part on depth images from the depth camera.

Embodiments of the technology may include a computer implemented method identifying real objects in a projection area, comprising: rendering a display area on a supporting surface using an processing device having an integrated projector both provided in a housing on the supporting surface; identifying a real object in the display area utilizing sensors provided in the housing, each of the sensors having a field of view defining a detection area including at least the display area and providing sensor image data, the identifying including weighting the image data relative to a quality of the images, the identifying based on the weighting; and rendering feedback in the display area regarding the real object in the display area.

Embodiments of the technology may further include any of the aforementioned embodiments in combination wherein the sensors include an RGB camera and an infrared detector, and the method includes isolating image capture for the RGB camera and isolating image capture for the infrared detector.

Embodiments of the technology may further include any of the aforementioned embodiments in combination wherein the method further includes retrieving user profile information for one or more users and identifying the real object based in part on information provided in the user profile.

Embodiments of the technology may further include any of the aforementioned embodiments in combination wherein the sensors further include a depth camera, and wherein the method identifies the real object based in part on depth images from the depth camera.

Embodiments of the technology may further include any of the aforementioned embodiments in combination and further including displaying a selection interface in the display area, the selection interface responsive to user input to identify the object based on the user input.

Embodiments of the technology may include an apparatus, comprising: a housing adapted to be supported on a surface; a processor in the housing; a projector in the housing, the projector configured to render a display area on the surface; a first image sensor and a second image sensor in the housing, each image sensor having a field of view of at least the display area; and a memory in the housing, the memory including code instructing the processor to monitor images from the first image sensor and the second image sensor and operable to detect one or more real objects in a detection area, the detection area encompassing at least the display area, the code operable to identify the one or more real objects in the detection area, the code operable to instruct the projector to provide feedback regarding the real object alongside the real object in the display area.

Embodiments of the technology may further include any of the aforementioned embodiments in combination wherein the first image sensor is an RGB camera and the second image sensor is an infrared detector, and the code includes assigning a relative weight to each of data from the RGB camera and the infrared detector, and the code operable to identify the one or more real objects is based on the relative weight of each said data.

Embodiments of the technology may further include any of the aforementioned embodiments in combination and further including a depth camera, the code assigning a relative weight to each of data from the RGB camera and the infrared detector and the depth camera, the code operable to identify the one or more real objects identifying the real objects based in part on depth images from the depth camera.

Embodiments of the technology may further include any of the aforementioned embodiments in combination wherein the code is operable to instruct the projector to display a selection interface in the display area, the selection interface responsive to user input to identify the object based on the user input.

Embodiments of the technology may further include any of the aforementioned embodiments in combination wherein the code is operable to retrieve user profile information for one or more users and to identify the real object based in part on information provided in the user profile.

Embodiments of the technology may further include any of the aforementioned embodiments in combination wherein the code is operable to isolate image capture for the RGB camera and isolate image capture for the infrared detector.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An integrated processing system, comprising:
a display projector in a housing adapted to rest on a supporting surface, the display projector adapted to display an interface in a display area on the supporting surface ;
a RGB camera in the housing;
an infrared emitter and infrared detector, wherein the RGB camera and the infrared detector each have a field of view, each field of view encompassing a detection area including at least the display area; and
a processor and memory including code operable to instruct the processor to monitor images from the RGB camera and the infrared detector and operable to detect one or more real objects in the detection area, the code operable to identify the one or more real objects in the detection area.

2. The integrated processing system of claim 1 wherein the code is operable to provide feedback for the one or more real objects using the display projector in the display area.

3. The integrated processing system of claim 1 wherein the code is operable to retrieve user profile information for one or more users proximate to the system and to identify the real object based in part on information provided in the user profile.

4. The integrated processing system of claim 1 wherein the code includes assigning a relative weight to each of data from the RGB camera and the infrared detector, and the code operable to identify the one or more real objects is based on the relative weight of each said data.

5. The integrated processing system of claim 1 further including code operable to control the RGB camera and the infrared emitter and infrared detector to isolate data capture for images from the RGB camera in a first time period and isolate data capture for images from the infrared detector in a second time period.

6. The integrated processing system of claim 1 further including code operable to display a selection interface in the display area, the selection interface responsive to user input to identify the object based on the user input.

7. The integrated processing system of claim 1 further including code operable to search publically available network content for identification information, the code operable to identify the one or more real objects identifying the real objects based in part on the publically available network content.

8. The integrated processing system of claim 1 wherein the code operable to identify the one or more real objects identifying the real objects based in part on images from the RGB camera and images from the infrared detector both matching a recognized object.

9. The integrated processing system of claim 1 further including a depth camera, the code operable to identify the one or more real objects identifying the real objects based in part on depth images from the depth camera.

10. A computer implemented method identifying real objects in a projection area, comprising:
rendering a display area on a supporting surface using an processing device having an integrated projector both provided in a housing on the supporting surface;
identifying a real object in the display area utilizing sensors provided in the housing, each of the sensors having a field of view defining a detection area including at least the display area and providing sensor image data, the identifying including weighting the image data relative to a quality of the images, the identifying based on the weighting; and
rendering feedback in the display area regarding the real object in the display area.

11. The computer implemented method of claim 10 wherein the sensors include an RGB camera and an infrared detector, and the method includes isolating image capture for the RGB camera and isolating image capture for the infrared detector.

12. The computer implemented method of claim 11 wherein the method further includes retrieving user profile information for one or more users and identifying the real object based in part on information provided in the user profile.

13. The computer implemented method of claim 10 wherein the sensors further include a depth camera, and wherein the method identifies the real object based in part on depth images from the depth camera.

14. The computer implemented method of claim 10 further including displaying a selection interface in the display area, the selection interface responsive to user input to identify the object based on the user input.

15. An apparatus, comprising:
a housing adapted to be supported on a surface;
a processor in the housing;
a projector in the housing, the projector configured to render a display area on the surface;
a first image sensor and a second image sensor in the housing, each image sensor having a field of view of at least the display area; and
a memory in the housing, the memory including code instructing the processor to monitor images from the first image sensor and the second image sensor and operable to detect one or more real objects in a detection area, the detection area encompassing at least the display area, the code operable to identify the one or more real objects in the detection area, the code operable to instruct the projector to provide feedback regarding the real object alongside the real object in the display area.

16. The apparatus of claim 15 wherein the first image sensor is an RGB camera and the second image sensor is an infrared detector, and the code includes assigning a relative weight to each of data from the RGB camera and the infrared detector, and the code operable to identify the one or more real objects is based on the relative weight of each said data.

17. The apparatus of claim 16 further including a depth camera, the code assigning a relative weight to each of data from the RGB camera and the infrared detector and the depth camera, the code operable to identify the one or more real objects identifying the real objects based in part on depth images from the depth camera.

18. The apparatus of claim 16 wherein the code is operable to instruct the projector to display a selection interface in the display area, the selection interface responsive to user input to identify the object based on the user input.

19. The apparatus of claim 16 wherein the code is operable to retrieve user profile information for one or more users and to identify the real object based in part on information provided in the user profile.

20. The apparatus of claim 16 wherein the code is operable to isolate image capture for the RGB camera and isolate image capture for the infrared detector.
